(19) United States
(12) Patent Application Publication
(10) Pub. No.: US 2003/0074421 A1
(43) Pub. Date: Apr. 17, 2003

(54) Internet access via specific server and via proprietary application for selecting and controlling content: remote and local

(76) Inventors: Mieko Kusano, Cambridge, MA (US); Robert A. Lambourne, Cambridge, MA (US); Lisa Holzhauser, San Carlos, CA (US)

Correspondence Address: Michael E. Marion, Philips Electronics North America Corporation, 580 White Plains Road, Tarrytown, NY, 10591, US

(21) Appl. No.: 09/929,257

(22) Filed: Aug. 14, 2001

(51) Int. Cl. G06F 15/16

(52) U.S. Cl. 709/219

(57) ABSTRACT

A software application running on a local server having one or more associated local storage media and interfacing with a web-server. The application represents data stored in the one or more local storage media in a GUI based on content. The web-server provides the local server with data in a compatible format for the application. The application organizes and presents data received from the web-server on the GUI based on the content of the data provided.

### FIELD OF THE INVENTION

The invention relates to a system and a method for providing control of a device, organizing information stored locally on the device, and access by the device to local and remote information, and, in particular, to providing the above via a dedicated software application providing a standard user interface.

### BACKGROUND OF THE INVENTION

Consumer electronic (CE) devices, such as home entertainment equipment (DVD players, DV camcorders, digital TV sets, etc), are digital processing and digital storage systems. Connecting these devices in networks makes it possible to share processing and storage resources. An example of a commercially available home network is a network implementing the 1394 IEEE standard as a transport protocol. Providing CE devices with access to the global network known as the Internet provides the CE devices with access to a wealth of data. Internet access can be provided to CE devices directly or through a local server. For example, a web-enabled TV set with a connection to the World Wide Web (WWW) via the Internet is commercially available.

The Internet provides user access to vast amounts of information provided by a large variety of sources (web-sites). Each source typically provides its own graphical user interface (GUI) for allowing the user to request and receive information from the source and to navigate within the source. The user is presented with a different GUI for each source that he accesses, in the form of web pages for example, so that the user must become familiar with each particular GUI before he can locate the information he is seeking. Furthermore, the user searching for specific information on the Internet must sift through large amounts of information in order to locate the desired information, causing the search process to be extremely time consuming. The current search is relatively inefficient, time consuming and unwieldy. The search process is extremely unsuccessful due to the user's inability to select from the large amounts of information and due to time constraints. Even filtered searches provide the user with unwanted information that is either not pertinent to the user's needs or is duplicated.

When a user locates desired information from an Internet source, he may decide to store or retrievably categorize the information locally. The user generally must step through levels of file structure to store the remote information in a desired location. When accessing the stored remote information, the user must again step through levels of file structure to locate the desired information. In addition, determining where the information is filed locally is an adhoc process. The same is generally true if the user determines to retrievably categorize the information locally, while the information itself remains remotely stored.

There are disadvantages to systems currently being used for allowing users to operate CE devices. For example, in a device driven system wherein a graphical user interface (GUI) is provided in which a user selects a device, a relatively high degree of freedom of control and customization is provided. However, functionality is added by adding on new devices and focus and entry must be through the hardware, not the content. This system is best suited for users having a high degree of technology skills, unlike the typical home entertainment user. In a task driven system wherein a GUI is provided in which a user selects a task to perform, the content is organized according to available tasks and flexibility is limited for adding on functionality as a system grows. This system is considered to be appropriate for users less skilled in technology, however at a great loss to flexibility.

### SUMMARY

There is a need for providing a user with an effective and efficient way to find desired information on the Internet, storing the information in a readily accessible and manageable manner, and using the information in a network of devices (such as a home network). There is a need for a consistent user interface regardless of the source of information. In addition, as web-enabled appliances, devices and computers access and store information from the Internet, there is a greater need for the providing a consistent user interface for access to stored information. Furthermore, there is a need for providing an effective and efficient way to organize and locate the stored information and for providing the user with easy access to the information without the user having to navigate through levels of file structure.

In addition, there exists a need for one consistent user interface via which a user can control a web-enabled device; store and access locally stored data; and effectively find and access information via the internet and store the acquired information in an integrated manner with locally stored data.

Accordingly, the present invention provides a web-server that responds to a user request from a local server for information by selecting from information available on the Internet in accordance with the needs and preferences of the user and device. In particular, the information requested by the user via the local server may be content-based information, such as musical preferences. A local server receives and processes user requests, determines user preferences according to the user requests, and provides the web-server with user preference data. Alternatively, the user preferences may be determined by the web-server via requests transmitted by the local server. In particular, the user preferences may pertain to content-based information, such as musical preferences.

The web-server is provided with information and data in a pre-defined format from at least one information or data provider, for example, a web-site. The information and data provided by the at least one provider corresponds to the category of content-based information requested by the user, such as music. The web-server uses the request for information and the user's preferences to provide to the local server that information which corresponds to the user's preferences. For example, where the request provided is related to content-based information (for example, “new releases of music”), the web-server may provide information which is tailored to the particular user based on the preferences (for example, new releases of music that is within the user's preference of “adult contemporary music”).

A software application may run on the local server. The software application may provide a unified organizational scheme for locally filing and presenting the information that is received from the web-server and stored by the local server. Thus, where the application relates to content-based information, such as music, the software application may organize the music content for a user that is stored locally and retrievable through the web-server. The application may also provide a uniform GUI that presents the information in a unified and straightforward manner. For example, where the application relates to content-based information, such as music, the GUI may present an integrated music list (whether the music is stored locally or may be accessed through the web-server), new releases that may be browsed through (transmitted via the web-server based on user preferences) and a purchasing and downloading vehicle (again, transmitted by the web-server based on user preferences). The web-server generates the appropriate content based on the user requests and preferences and provides data in a format compatible with the GUI to provide the information to the local server. The software application may also operate at least one CE device, including controlling the CE device, accessing information to be used by the CE device (including storing, organizing and retrieving the information) and providing Internet access to the CE device.

Thus, the invention provides a local server that interfaces with a remote server. The local server runs a software application and may provide a GUI to the user. The software application organizes information stored locally with information that is retrievable from the remote server. The information retrievable from the remote server pertaining to the software application may be in accordance with user preferences transmitted from the local server and/or stored at the remote server. The local information and the information that is retrievable from the remote server is provided in a pre-defined or pre-designated format that enables the local server to utilize, organize, manage and integrate the received data. In particular, in the case of data related to the GUI, the pre-defined format enables the GUI to provide the user with an integrated presentation of information related to the software application, whether the information is stored locally, or on the remote server. The GUI allows the user to navigate through the information, whether stored locally or on the remote server.

As noted, the remote server provides information in a pre-defined or pre-designated format that is compatible with the capabilities of the application and the GUI, thus comprising the unified presentation of data to the user pertaining to the software application (which may be a content-based application, for example, music). The remote server may be provided with data that is pertinent to the software application in the requisite format from one or more content providers. The remote server may thus act as a repository and/or gateway of content for the local servers, acting to provide data in the required format, as well as filtering the content provided based on user preferences.

The software application may also accommodate functionality, whether it is the control of a local device (that is part of a local network, for example) or whether it is functionality accessed via the remote server. For example, the GUI provided by the application may allow the user to operate the control of a device, such as a CE device, attached to the local server, access a memory for storing and retrieving information used by the device (and which may be displayed to the user in a content portion of the GUI), and find, access and/or purchase selected information located on the remote network. Data received from the remote network is in a predefined format that enables the application to utilize, organize, manage and integrate the received data, as well as present such integrated data via the GUI.

As noted, information accessed from the remote network is formatted in a pre-defined format so that it can be stored in the device's storage seamlessly with locally stored information. The remote server may communicate via the local server to the local device in order to provide information from the remote network to the device. The web-server receives user requests and may select information according to preferences of the user and/or a profile associated with the device. The selected information is retrieved by the web-server from at least one web-site on the remote web. The web-site may provide the information in a predefined format. The web-server transmits the selected, formatted information to the device that requested it. The pre-defined format allows the device to utilize, organize, manage and integrate the received data. The information received from the web-server fits in with the device's GUI.

The present invention also includes a method for operating a device having the capability of communicating with a remote network. The device, for example, comprising a local server running a pertinent software application, transmits a user request from the device to a web-server of the remote network. The web-server recognizes a profile of the user and/or the device. The web-server selects information provided by at least one web-site on the remote network, in accordance with a user preference and/or device profile. The at least one web-site provides the information to the web-server in a pre-defined format, and the web-server transmits the information to the device. The device receives the data, and the pre-defined format allows the device, using the software application, for example, to utilize, organize, manage and integrate the received data. Also using the software application, for example, the device presents the information into a GUI pertaining to the device and presents the GUI to the user. The GUI integrates data received from the network together with data residing within the device, for example, by storing and categorizing the data in an integrated manner and presenting the data to the user. The GUI enables the user to control the device, store and access data on the device's associated storage, and transmit requests to the web-server, among other things.

Finally, the present invention is not limited to the circumstance where content data and information is transmitted from web-sites in a pre-defined format which, in turn, is compatible with the application of the local server and/or the uniform or customized GUI associated with the local server. Web-sites may alternatively supply content data in a format for which the local server has no applicable decoder. In addition, the web-sites may not provide any GUI control data, or may provide GUI control data which may not be compatible with the GUI associated with the local server. (For example, HTML may be supplied by the web-sites, but may not be compatible with the GUI of the software application.) In such alternative embodiments, the remote web-server may also process the information received from the web-sites so that it is in the pre-defined format useable by the local server (including, when applicable, the GUI associated with the local server). Alternatively, software associated with the local server may provide a conversion of the supplied content and/or GUI control data into a format that is compatible with the local server, including, when applicable, a format that is displayable by the GUI. In this case, if the local server also performs the other services of the remote web-server described above, the web-server may be eliminated from the system and the local server may interface with the web-sites without an interposed web-server.

### BRIEF DESCRIPTION OF THE DRAWINGS

The above and other objects, features and advantages of the present invention will become more apparent in light of the following detailed description of an exemplary embodiment thereof taken in conjunction with the attached drawings in which:

FIG. 1 is a block diagram of the system in accordance with the present invention;

FIG. 2 is a block diagram of function modules of a software application running on a local server in accordance with a preferred embodiment of the present invention;

FIG. 3 is a block diagram of function modules of a web-server in accordance with a preferred embodiment of the present invention;

FIG. 4 is a representation of the system in accordance with a preferred embodiment of the present invention;

FIG. 5 is a flowchart of the method of a preferred embodiment of the present invention;

FIG. 6 is a representation of a view of the graphical user interface of a local network element in accordance with a preferred embodiment of the present invention; and

FIG. 7 is a representation of a second view of the graphical user interface of a local network element in accordance with a preferred embodiment of the present invention.

### DETAILED DESCRIPTION OF THE PREFERRED EMBODIMENTS

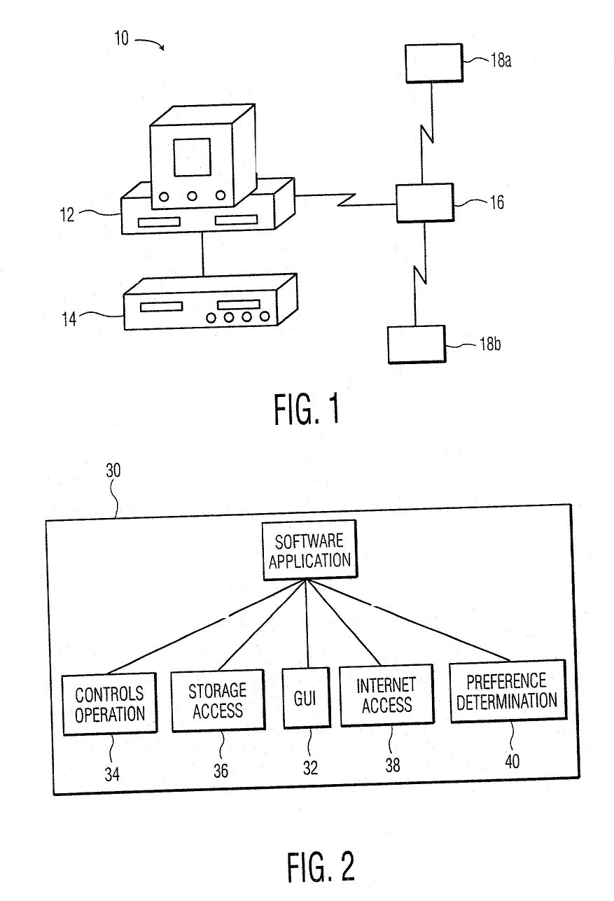

Turning now to the drawings, in which like reference numbers identify similar or identical elements throughout the several views, in particular with reference to FIG. 1, a local server 12 is operably connected with a CE device 14. The local server 12 and the CE device 14 (and other such devices) thus comprise a modest “local network”. The local server 12 interfaces with the Internet via a remote server 16. At least one data provider (web-site) 18 provides data to the local server 12 via the remote server 16.

The local server 12 may be a PC, other display (such as a TV) that has a control unit and storage attached to it (for example, via a set top box), or the like. The local server 12 may also be integrated within the CE device 14.

The CE device 14 (and other devices which may be similarly networked) may also have a processor for controlling the device, as well as storage for storing information used by the device. Alternatively, the CE device 14 may receive control commands directly from the local server 12 running a device control application. The CE device 14 may also interface directly with the remote web-server 16. Device 14 may be a home appliance or consumer electronics device such as a device associated with home entertainment, as in a device for playing music, hereupon referred to as a music set. As noted, the local server 12 and the device 14 may be integrated, for example, a CD player application integrated with a PC. Alternatively, a smart appliance or CE device may comprise the local server 12 and the device 14, where the local server 12 is the processor and associated application software for the web-enabled device.

The local server 12 hosts at least one software application that generates a GUI that is presented on a display of the local server 12. The application software manages and organizes data that is stored locally and which may pertain in whole or in part to the CE device 14 consistent with the application and displays content via the GUI. The application software may also provide related function, including control of the networked CE device 14, and display such control functions on the GUI.

When requested by the user via the GUI, the remote web-server 16 provides the local server 12 with information from at least one data provider, such as data providers 18a and 18b in FIG. 1. Data providers 18a, 18b may be web-sites on the Internet, and remote web-server 16 may be viewed as part of the Internet. The information provided by data providers 18a, 18b is in a pre-defined format that is compatible with the software application of the local server 12 and, in particular, the GUI of the software application. The web-server presents information provided by the data providers 18a, 18b to the local server 12, so that it may be integrated with locally stored data and displayed in an integrated manner on the GUI. The information provided by the web-server 16 is displayed on the GUI along with any local content in an integrated and seamless manner. For example, if the information selected by the user is content-based, the GUI presents locally stored information and information that may be accessed via the remote web-server 16 together.

The local server 12 and/or the remote server 16 may further filter the information provided to the local server from the Internet according to recorded user preferences. For example, where the information is content-based, the local server 12 and/or the web-server 16 may have associated preference files for the user that limits the content information that is provided to the software application that falls within the preference. The information provided by the data providers 18a, 18b may be required to have standardized data field(s) that identify the content of the information provided.

As noted, the software application being run by the local server may be provided with content-based information and/or functional information from web-server 16. The web-server 16 is provided with such information in the requisite pre-defined format from data provider(s) or web-site(s) 18a, 18b. The user accesses the information on the web-server 16, for example, when a data request is made to the web-server 16 by the user via the GUI. (Because of the integrated and seamless nature of the GUI, the user may not be aware of where the request is directed, either locally or to the web-server 16.) The data request may provide a download of information from the web-server 16 to local storage, whereupon the information is appropriately integrated by the software application with other locally stored information, as well as integrated in the information presented by the GUI. Alternatively, the information may remain stored remotely at the web-server 16 and/or web-site 18a, 18b and accessed (for example, streamed or downloaded) as needed by the application. In that case, the remotely stored content information is represented by the GUI integrated with the locally stored content data and information. Examples of content data and information that may be stored remotely or locally, and which may be moved from remote storage to local storage include literature, movies and music. Examples of functionality data include appliance and device control programs and application programs, such as music playback programs.

In the described embodiment, the content data and information transmitted from web-site(s) 18a, 18b are in a pre-defined format which, in turn, is compatible with the application running on the local server, including, where applicable, the uniform or customized GUI associated with the local server. Web-site(s) 18a, 18b may alternatively supply content data in a format for which the local server has no applicable decoder. In addition, web-site(s) 18a, 18b may not provide any GUI control data, or may provide GUI control data which is not compatible with the customized and uniform GUI associated with the local server. (For example, HTML may be supplied by the web-site(s) 18a, 18b, but may not be compatible with the GUI of the software application.) In such alternative embodiments, the web-server 16 or the local server 12 also provides (in addition to the other processing described above) a conversion of the supplied content and/or GUI control data into a format that is compatible with the local server, including, where applicable, a format that is displayable at the GUI associated with the local server. Where the local server 12 provides the conversion, the web-server 16 may provide preference processing or may be eliminated, wherein the local server would then also provide preference processing and any other services of the web-server described above.

Returning to the principle exemplary embodiment described above, where the web-site(s) 18a, 18b provide content data in a pre-defined format, FIG. 2 depicts the modules of the software application 30 that are run on the local server 12. The GUI module 32 provides an integrated GUI for the functional aspects of the application 30, including operation control 34, storage access 36 and remote server (Internet) access 38. Controls operation module 34 transmits instructions to control and receive status data from the functions associated with the local server 12. For example, where the local server 12 is a PC and the software application is music, the control operation module 34 may control a CD player of the PC and the GUI may provide the user with a graphical interface that initiates the CD player. (The user may simply be presented with a “play” option for a music selection via the GUI and not necessarily be presented with the device that will play the selection.) Alternatively, where the local server 12 is a set top box of a TV that interfaces with a CD player 14, or where the local server 12 is part of a CD player device 14, the control operation module may provide control signals that are recognized by the CD player 14 device's controls and the GUI may provide the user with a graphical interface for playing the CD player. Through the GUI the user can operate and observe the status of the device's controls.

The storage management module 36 provides access to information stored locally, for example, by a storage medium associated with the local server 12 and/or device 14. Storage management module 36 provides a filing structure for information that is stored locally and retrieves the information upon user request. Via the GUI the user can access, browse and delete data stored locally. However, as described below, the GUI may present an integrated data structure with data that is stored at the remote server and the user may not be aware where the data is stored. Thus, the location of information may be stored on one or more local storage devices, and is managed by the software application and hidden from the user. Through the GUI the user accesses the information via a graphical representation and the user is never exposed to a file structure. As described further below, when storing information accessed by the web-server 16 from a remote source, the software application seamlessly stores the information from the remote source with the local information already stored on the device's storage, which will be discussed in greater detail below.

Internet access module 38 allows the user to communicate with the web-server 16 and thus provides access to information stored remotely at the web-server 16, received from web-sites 18a, 18b. As to presenting data that is available via the web-server 16, the web-server 16 may provide data formatted to the software application and thus are also formatted to the integrated GUI of the local server. The data received from the data providers 18 may be in the pre-defined format. Thus, information and data available to the user on the web-server 16 is presented to the user via the GUI 32, and integrated seamlessly with any information that is stored locally pertaining thereto. The GUI 32 may also enable the user to download information or data from the web-server 16, for example, where the user selects content or functionality that is remotely stored at the web-server 16 using the GUI. When downloaded, the storage access module 36 integrates the downloaded data in a file structure together with previously stored local data or information. The GUI 32 continues to present the data or information in an integrated manner, regardless of where stored. Thus, the GUI functions as a portal to a local and a remote data collection.

In addition, preference determination module 40 provides preferences for information and data that is requested from the remote server 16. Preferences pertaining to a data request may be entered by the user via the GUI, or may be constructed over time by the application itself based on user actions and selections. The preferences are used by the web-server 16 in determining the information that is sent to the local server 12, as described below.

A specific software application may apply to different types of devices associated with the local server. Alternatively, a different segment of a comprehensive software application may be used for each type of device. For example, a comprehensive software application may run on local server 12 and device 14 may use an applicable software application from the comprehensive software application. Other devices associated with the particular software application may also use the applicable software application. Settings can be made, upgrades and customization added via the local server 12. For example, a music set, a DVD player, a washing machine and an oven may all be associated with a specific software application designed to associate with that particular appliance or device and supply it with information appropriate for that appliance or device. A comprehensive software application residing on the local server 12 may provide those particular applications.

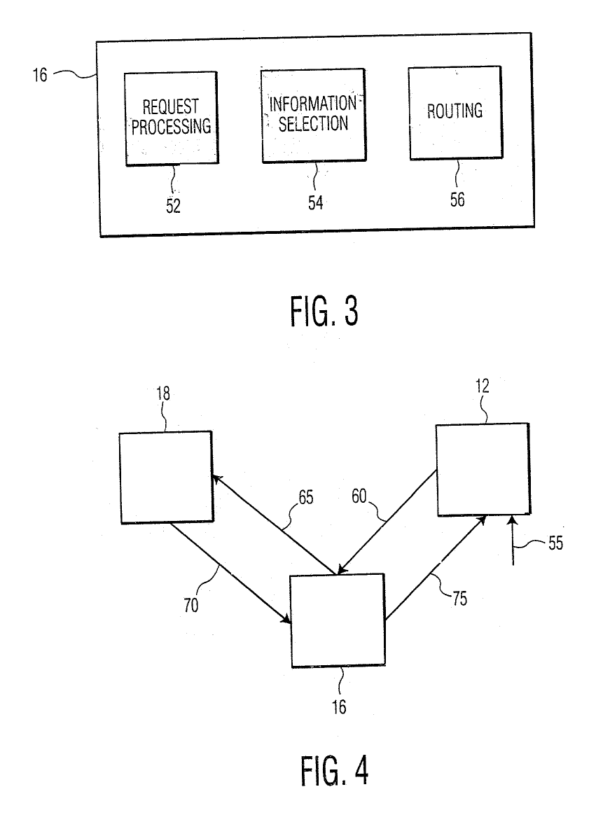

When a user requests information via the local server 12 from the web-server (which may be a request for content and/or functional information), the web-server 16 receives and processes the request. The processing of the web-server 16 is shown at FIG. 3. Request processor module 52 receives the user requests (including the preferences related to the request) and recognizes a profile for the device (such as a device identifier) making the request. The profile is recognized by receiving profile data with the request data, and/or looking up profile data for the device/user that was entered by the user and stored by the web-server 16 upon registering the device/user with the web-server's service.

Information selection module 54 selects and retrieves selected information in accordance with the device/user profiles and the user request. In addition, the information is preferably selected to eliminate duplication of information. Finally, the information is filtered by the web-server 16 according to the received user preferences. The information is thus selected according to the content of the information, and not according to the source (for example, the web-site) where the information originates. In one embodiment, the information may be selected from a dynamic database managed by the web-server 16 that is continually updated with new information from one or more web-site(s) 18. The web-server 16 selects the web-sites 18 that provide information to the database in accordance with the user/device profile and/or procedural considerations. The operator of the web-server 16 may make an agreement that the selected web-site(s) 18 provide information required to maintain the database. Alternatively, the web-server 16 may access the information provided by the web-sites 18 by using indexes pointing to the selected information. The indexes are addresses for where each indexed piece of information resides on web-site(s) 18. In this way the web-server 16 manages the flow of information and directs it, without having to actually store it. The web-server 16 may also initiate a search for selected information located at web-site(s) 18.

Information retrieved from the web-sites 18 may be provided to the web-server 16 by the web-sites 18 in a pre-defined format. Alternatively, the web-server 16 processes the information received from the web-site(s) so that it is in the pre-defined format. However, in the preferred embodiment the web-server 16 retrieves information from web-sites 18 with which it has a prior agreement such that the information is formatted according to the webserver's 16 specifications. The pre-defined format is correlated to the format required by the software application of the local server 12, to enable the information to be seamlessly integrated with information stored locally when downloaded and to integrate and present the remote information along with the locally stored information in an integrated manner via the GUI.

The routing module 56 transmits the selected information, formatted in the pre-defined format, to the local server that requests it.

Upon receipt of the data by the local server 12, module 38 of the pertinent software application recognizes, retrieves and delivers appropriate elements of the data to the other modules of the software application. The information received from the web-server 16 is ready to be displayed in the software application's own GUI for the user to browse through (along with similarly stored local data, if appropriate). If requested by the user, the content data may be downloaded and stored with the local data collection and then presented by the GUI integrated with similarly stored local data, if appropriate. Where the local server 12 is integrated with a device, such as device 14, the user may browse information received from the web-server 16 via a physical control interface on the device.

As previously noted, for the embodiments described with respect to FIGS. 2 and 3 above, content data and information are generally transmitted from web-site(s) 18a, 18b in a pre-defined format which, in turn, is compatible with the local server, including, for example, a uniform or customized GUI associated with the local server. Web-site(s) 18a, 18b may alternatively supply content data in a format for which the local server 12 has no applicable decoder. In addition, web-site(s) 18a, 18b may not provide any GUI control data, or may provide GUI control data which may not be compatible with the customized and uniform GUI associated with the local server. (For example, HTML may be supplied by the web-site(s) 18a, 18b, but may not be compatible with the GUI of the software application.) In such alternative embodiments, as noted above, web-server 16 may process the information received from the web-site(s) 18a, 18b so that it is in the pre-defined format required by the software application, including, when applicable, the GUI associated with the local server. In that case, web-server 16 has at least one conversion module in FIG. 3 for providing a conversion of the supplied content and/or GUI control data into a format that is compatible with the software application associated with the local server 12 and/or is displayable by the GUI module 32. Alternatively, the software application 30 (or other software associated with local server 12) may provide a conversion of the supplied content and/or GUI control data into a format that is compatible with the local server 12 and/or displayable by the GUI module 32. In this case, if the software application 30 of FIG. 2 (or other software associated with the local server 12) incorporates the other processing modules of the web-server 16 (such as those shown in FIG. 3 and described above), the web-server 16 may be eliminated from the system. In that case, the local server 12 interfaces with the web-site(s) 18a, 18b without an interposed web-server 16, and the local server provides data conversion and preference filtering.

In a first example based on the principle embodiment described above (i.e., where the web-sites 18a, 18b provide data in a pre-defined format and there is a remote web server 16 providing the portal services shown in FIG. 3 for a software application 30 as shown in FIG. 2 running on a local server 12), the local server 12 is a PC that is locally networked with a CD carousel that houses a user's CD collection. The PC also supports an audio player that plays a collection of MP3 music files stored on the PC. The software application being run by the local server 12 is a music application that is principally content-based. The software application provides an integrated list of the CDs stored in the CD carousel 14 and the MP3 files. Thus, the software application interfaces with the processor of the CD carousel 14 to receive the identities (from data fields of the CDs) of the CDs contained therein. The list is provided to the user via the GUI generated by the software application, for example, via the display of the PC.

The music application also provides the user with controls on the GUI for playing music selected from the list. The user highlights a song or album in the music list and activates a “play” command on the GUI. The software application then sends the appropriate command to either the MP3 player or the CD carousel to begin the song or album. Other controls provided by the GUI may be, for example, play, rewind, forward, stop.

The GUI of the software application may allow the user to browse through music available via the web-server 16. As noted, the web-server 16 may provide the local server 12 with music titles in a format that is compatible with the software application and the GUI, and may thus be presented to the user and browsed through. As previously noted, the music presented to the user may be filtered by a preference filter at either the local server 12 or the web-server 16, thus presenting music titles via the GUI that are in accordance with the user's preferences. The music titles are provided by one or more web-sites 18, which provide the titles in a format that is compatible with the software application and the GUI. (Reference number “18” will be used to represent one or multiple web-sites, depending on the context, as were reference numbers “18a” and “18b”.) The software application may allow the user (through the GUI) to download or otherwise purchase music via a web-site 18. The user may, for example, click on the music title in the GUI, thus initiating a download of an MP3 file from the web-server 16 to the local server 12. The software application then integrates the received MP3 file with the other MP3 files stored locally and integrates the title with the other titles on the music list presented by the GUI.

Alternatively, the user may click on the music title in the GUI, but the music file remains stored at the web-server 16 or the web-site 18. The software application still integrates the title with the other titles on the music list presented by the GUI. When the title is selected to be played by the user via the GUI, as described above, the software application may initiate an audio stream (or a download) of the selected music from the web-server 16 (or from the web-site 18 via the web-server 16) to an appropriate local audio player.

Other music content that may be requested by the software application of the web-server 16 via the GUI include recent music releases or releases of possible interest, based on the user preferences. The web-server 16 selects information (from the comprehensive and preformatted data provide by web-site(s) 18) in accordance with the device/user profiles and the actual request. Some examples of the selected information include Internet based jazz radio stations, latest heavy metal releases, all albums produced by T-Bone Burnett and journal articles about the Beatles.

Other music content that may be requested by the software application of the web-server 16 via the GUI include presenting an Internet radio tuner and receiving a broadcast from the web-server 16 for the selected station. The web-server 16 recognizes the source of the request, namely the user and device, and looks up the profile for each. The signals are provided to the web-server 16 in a compatible format by one or more web-site(s) 18.

As noted, when information is provided by the web-server 16 to the software application running on the local server 12, the information includes specific data arranged according to a pre-defined format, so that it is compatible with the application. Where information is downloaded for music titles, for example, pre-defined formatted data for a song may include data fields for the song title, duration, album name, artist name, song number on album, genre, etc. A picture file of the album cover, audio and/or video clips may also be received and clicked on for a preview via the GUI. Purchase of the music title may be via a download of an MP3 file (once purchasing data is sent through the GUI, or transmitted from a stored file associated with the software application) as described above, or may initiate a shipment of a CD via an associated web-site 18.

As previously noted, the user can access his own music collection via the GUI from among music collections of other users, select the choices to be displayed according to genre, artist, etc., browse the choices displayed, select and play a music selection. Although the selection may be stored on one of several storage devices, such as a CD carousel, the device's hard disk or the storage device of computer 14a or a different device 14b in the network, the user is not exposed to the location, name, and type of the file, or to any file structure. The GUI provides virtual controls for operating the physical controls such as for playing the selection.

In the above example, the software application is principally focused on content information, namely music and, in particular, a user's musical collection and preferences. In another example, for example, where the device 14 is an appliance such as a washing machine, the information processed by the application is primarily functional, such as programs for upgrading the machine's processing power, diagnostics and software repairs. The software application may be run on a processor on the appliance that comprises the “local server” 12. The local server provides a GUI for display on a limited screen on the appliance itself. Via the GUI, the application provides the user with the ability to operate the machine's controls and access locally stored functional information, such as specially stored wash cycles that may be programmed into a memory via the GUI. The appliance may have an interface with a web-server 16 that may provide, for example, a list of upgrades, diagnostics, patches, etc. that may be downloaded to the appliance. The web-server 16 provides the information in a pre-defined format that is compatible with the software application and may provide an integrated output of stored files via the GUI. For example, if a certain specialized wash cycle is downloaded from the web-server 16 to the local server 12, for example, an improved “gentle cycle”, the format allows the local server to integrate the newly added cycle among the locally stored cycles and to present it with the other cycles in an integrated GUI to the user.

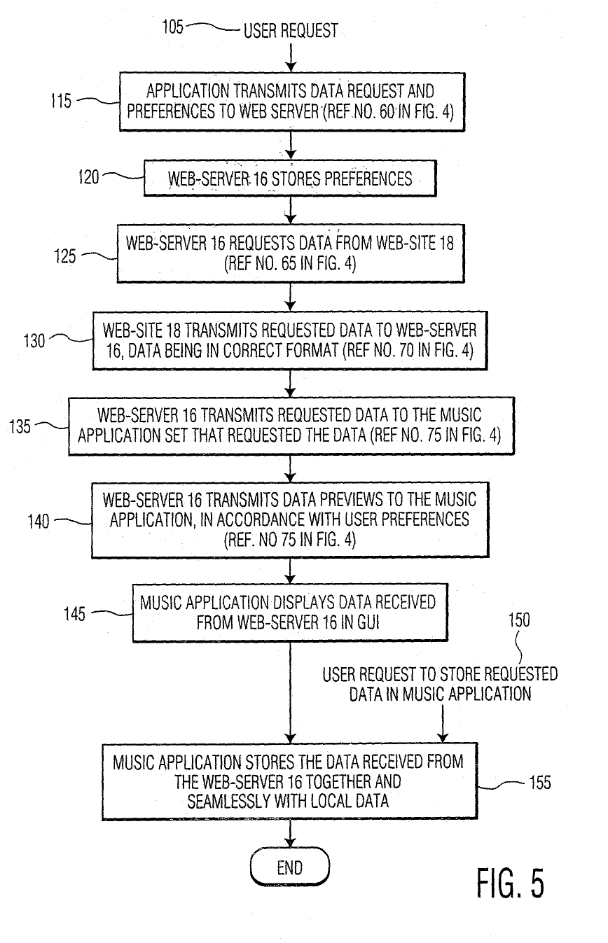

FIG. 4 shows the flow of data or information between a local server 12 running the software application, the web-server 16, and a web-site 18 providing the underlying data. The local server 12 is conceived as networked with or part of at least one device (such as device 14 of the prior discussion) which it controls at least in part via the software application. A data request 55 is made by a user via the GUI associated with the software application to access remote information from the Internet, in particular from web-server 16. The application causes local server 12 to transmit data request 60 to the web-server 16. Data request 60 also represents the transmission of user preferences, stored by the application running on local server 12, to the web-server 16. Web-server 16 in turn transmits data request 65 to web-site 18 based on data request 60, including the preferences. Web-site 18 provides the requested data (such as content data) to web-server 16 in data reply 70. The data included in data reply 70 is in a pre-defined format that is compatible with the application (and the associated GUI) running on the local server 12, or which is in a format that may be transformed by the web-server 16 into the pre-defined format for the software aplication. At data reply 75, the information is transmitted from the web-server 16 to the local server 12. In addition, at data reply 75, the web-server 16 may transmit previews of information in accordance with the stored user preferences. In one embodiment, the web-server may send selected announcements (selected similarly to the information) and information at any time, even when unsolicited.

As previously noted, the data reply 75 is in a format that is compatible with the software application, including the file structure and the GUI. Thus, the information may be stored and displayed with locally stored content or other related data in a seamless manner.

The various data requests shown in FIG. 4 need not occur in a close temporal sequence, but may be separated in time throughout a day or longer interval. In addition, one request 60 from the local server may provide an ongoing request that results in multiple subsequent data replies 75. For example, a user may use the local server 12 to provide a request (including preferences) 60 to the web server 16. The web-server 16 may then transmit multiple data requests 65 to one or more web-sites 18 over time and receive corresponding data replies 70 from the web-site(s) 18. Alternatively, one data request 65 from the web-server 16 to the web-site(s) 18 may include instructions that the request is “ongoing”, and that any subsequent information that corresponds to the preference should be sent in a data reply 70. Any information received in the multiple data replies 70 is provided in data reply 75 to local server 12.

Such a standing request for information according to user preferences results in information corresponding to the preference to be automatically downloaded to the local server on a continuing basis. The data is acquired by the local server without specific user action, apart from providing the preferences in the initial data request. (However, even the preferences included in the initial data request may be based upon the user's patterns of usage.) Much of the data corresponding to the user preferences may therefore be downloaded at night or at other times when the user is not using the device associated with the local server. Accordingly, when the user does engage the device (for example, using the GUI of the application), the information corresponding to the user preferences will already be available at the local server for the user to access, browse, etc. Certain information may still require user interaction to download. For example, the information provided over time may be a list of new music releases, along with audio clips, liner notes, etc. The user may still have to initiate a download of the actual music file by purchasing it on-line.

The continual downloading of information, of course, enables a relatively large amount of data to be downloaded over a relatively low bandwidth connection over time intervals when the user is not using the system, thus eliminating much of the waiting time to the user when using the system.

A flowchart 100 is shown in FIG. 5 of the method of an exemplary preferred embodiment for providing a user of a device 14 running a software application, such as a music application, with remote data from the Internet. (Thus, the device 14 may be viewed as incorporating the local server 12 discussed above.) The user submits a request for application-related data from the Internet via the application's associated GUI or via the device's physical controls in step 105. The application transmits the user's requests as well as related preferences that have previously been stored or compiled by the application software. For example, if the user request 105 is “new releases”, the application may transmit a data request for “new releases of country music”, in accordance with the user's preference of country music.

The request for data from the Internet is sent to web-server 16, along with the preferences in step 115. The transmission of user preferences can be done at any time that the element 14 is in communication with the web-server 16.

At step 125, the web-server 16 requests data from at least one web-site 18 and includes user preferences in the request. At step 130, web-site 18 transmits data conforming to the request to the web-server 16, the data being transmitted in a pre-defined format that is compatible with the software application and, where applicable, the GUI. Alternatively, the web-server 16 downloads and stores pertinent information from web-site 18 in a database and selects information from the database based on the user request and preferences.

At step 135 the web-server 16 transmits the requested data to the device 14. The music application processes the received data and presents it to the user via the GUI. For example, where the data is available music of a particular category (a preference), the received titles and the music that is stored locally may be displayed in an integrated manner on the GUI, i.e., in a manner that only displays the music content, and not the file structure, location, etc. of the music. At step 140 the web-server optionally transmits data previews of selected music, for promoting sale of the titles. As noted, the music displayed on the GUI is selected in accordance with the preferences of the user stored at step 120. The previews can be sent at anytime that the device 14b and web-server 16 are communicating, and the data selected for the previews may be selected in accordance with preferences recently received by the web-server 16, as opposed to stored preferences.

At step 145 the music application receives the requested data in the pre-defined format from the web-server 16. As noted, this enables the software application to integrate the data with locally stored data of the same content, as well as present the data with locally stored data in an integrated fashion on the GUI. When the received data is a collection of data to browse through, such a list of music titles, the user may decide to purchase and download a selected title (via, for example, a download of an MP3 file) and/or make a new user request 105.

At user request 150, the user requests that data received from the web-server 16 to be stored locally by the local server and music application. At step 155 the title is downloaded and stored locally in a manner such that the data seamlessly fits with the local collection of music data and is displayed as so integrated by the GUI.

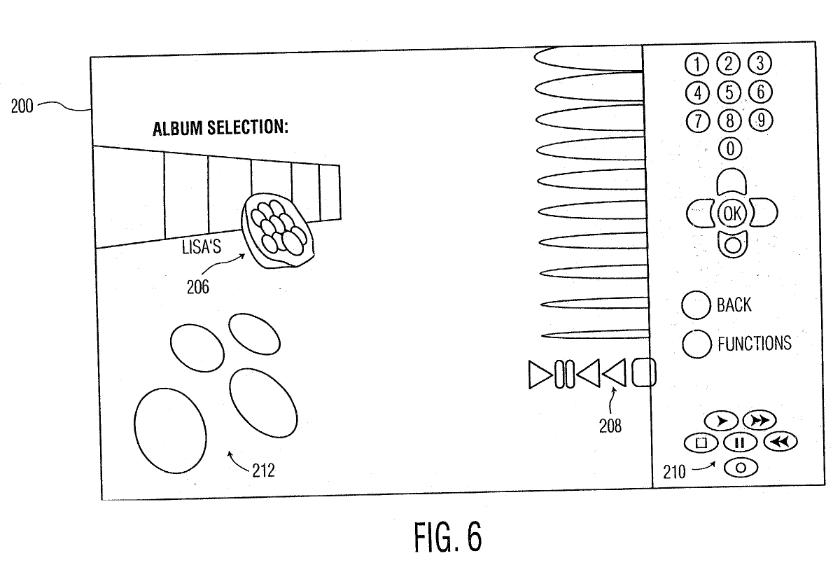

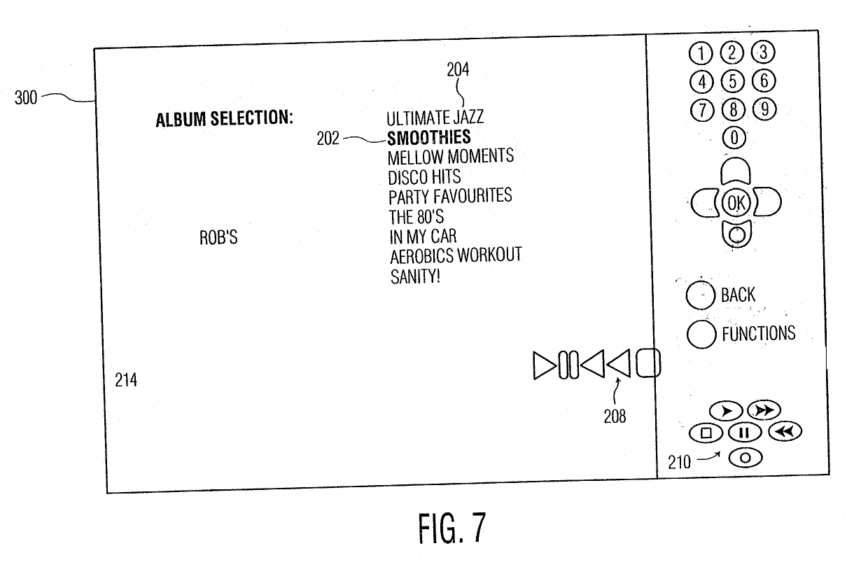

Two exemplary views 200, 300 of the GUI of the device 14 as generated by the music application are shown in FIGS. 6 and 7. The views 200 and 300 are views of a content driven GUI for a content driven software application for playing and managing a music set or collection. The content driving the views 200 and 300 is music. In view 200, music item 202 (an album in this case) is selected from user Lisa's rock collection 204. The albums in Lisa's rock collection may be stored in MP3 files that run on the device and a CD storage and player associated with the device. As seen, the items in Lisa's rock collection is presented by the GUI in an integrated fashion and does not even display where or how it is stored locally. In addition, by operating controls 208 presented by the interface, Lisa may cause the application to play a selected album. As seen, the controls 208 also do not distinguish the device or facet of the local device that will play the album.

In view 300, music item 202 (a playlist in this case) is selected from user Rob's collection of playlists 204. The user selects his/her own collection using the palette tool 206 of the GUI, which contains the names of different users that have created a particular database of music and music preferences using the software application. The palette tool 206 is a two-sided tool that is flipped to either side by the user. One side of the palette tool 206 is for selecting a particular user from the available users, and the other side is for selecting genres of music, playlists, albums collected, etc. for the selected user. In the GUI displayed in FIG. 7, a number of “playlists” that Rob has created using the music application is shown. These playlists are lists of songs that are found in a local CD collection, MP3 files, etc. Again, when Rob depresses the play button in control items 208 for a list, the software application accesses the music tracks, wherever stored, and plays them in succession. The GUI simply presents the content of the music to Rob, not where the files are stored and played from.

The palette tool 206 is shown as being receded into the background of the view. Upon selecting the palette tool 206, it advances to the foreground of the view. Control items 208 are consistently shown on each view of the GUI for operating the associated device that plays a selected music item 202, as described above. Additional control functions 210 are available for operating the controls of the device. Certain other action options 212 are available for user actions. The action options 212 are shown faded into the background in view 200 and displayed in the foreground in view 300. Other than the “web store” selection 214, the user action options at 212 are associated with the selected music item 202. For example, if the “burn CD” option is selected by Rob when his “smoothies” playlist is highlighted as shown in FIG. 7, the software application will retrieve the playlist in succession, make the appropriate format adjustments (for example, MP3 into CD format), and record a CD using a CD recorder that is part of or associated with (networked) with device 14.

The web store selection 214 of FIG. 7 provides a portal to remote collections available on the Internet. When the user selects this option, the local server hosting the software application access a remote server (such as web-server 16) and receives titles of music available to purchase, which may be in accordance with user preferences, as previously described. The titles supplied by the web-server 16 are formatted to be compatible with the music application and, in particular, the display of the GUI. The GUI may then provide a purchase and download option for selected titles from the web-server 16. By purchasing an album that is downloaded from the web-server 16 (for example, in an MP3 file), the music application then stores the file locally and integrates the album title into the local collection that can be displayed and played via the GUI (for example, as shown in FIG. 6).

Aspects that may be displayed via the GUI for a music application include the user's name, genre of a selected collection, music content of a selected collection, playing and purchasing functions integrated within a content-based application. The GUI of the application provides a meaningful display of layers and levels of content wherein the various aspects of the display are able to move between the foreground and background of the display in accordance with the user's current selection.

The present system and method provide the inherent advantages of providing the device 14 with remote Internet based information relevant to the element's application, filtering out of unrelated information, storing remotely accessed information automatically, logically and seamlessly with analogous local data, and providing a consistent GUI for accessing local and remote information as well as operating the controls of the device 14.

The system and method of the present invention is illustrated using a home network having a music set. It is contemplated that the described system and method may be applied to many types of networks and devices. For example, devices in a school, hospital, business, or military-based network similarly will benefit from the dedicated software application which provides for each device: access to filtered remote information; storage, organization and access to local information for the device and network; and operation of the device.

Finally, as previously noted, for the embodiments described above with respect to FIGS. 4-7, content data and information are generally transmitted from web-site(s) 18 in a predefined format which, in turn, is compatible with the local server, including, for example, a uniform or customized GUI associated with the local server 12. Web-site(s) 18 may alternatively supply content data in a format for which the local server has no applicable decoder. In addition, web-site(s) 18 may not provide any GUI control data, or may provide GUI control data which is not compatible with the customized and uniform GUI associated with the local server 12. (For example, HTML may be supplied by the web-site(s) 18, but may not be compatible with the GUI of the software application.) In such alternative embodiments, as previously noted, web-server 16 may then include processing steps (for example, between steps 130 and 135 in the embodiment of FIG. 5) to convert the information received from the web-site(s) 18 so that it is in the pre-defined format useable by the local server (including, when applicable, the GUI associated with the local server). Alternatively, the software application (or other software associated with local server 12) may provide a conversion of the supplied content and/or GUI control data into a format that compatible with the local server, including, when applicable, a format that is displayable by the GUI associated with the local server. Thus, referring to the embodiment of FIG. 5, a step may be interposed between steps 140 and 145, wherein the local server converts the content and/or GUI control data.

In this latter case, another alternative embodiment may incorporate and consolidate all of the steps undertaken by the web-site 16 shown in FIGS. 4 and 5 into the local server 12. Thus, the local server 12 may transmit data requests directly to the web-site(s) 18 and receive data, data previews, etc. directly from the web-site(s), as well as manage all preference processing regarding the received data. Thus, the web-server 16 may be eliminated in the embodiment. The local server 12 interfaces with the web-site(s) 18 without an interposed web-server 16, and the local server provides data conversion and preference filtering. (Such an embodiment (i.e., without an interposed web-server 16) may also be provided where the web-site(s) 18 provide data in a pre-defined format for the local server 12.)

The following two documents are hereby incorporated herein by reference:

(1) Co-pending U.S. Ser. No. 09/165,682 (attorney docket PHA 23,484) filed Oct. 2, 1998 for Eugene Shteyn for CONTROL PROPERTY IS MAPPED ONTO MODALLY COMPATIBLE GUI ELEMENT. This document relates to an information processing system that has an electronic device and a controller for control of a functionality of the device. An abstract representation of the functionality is provided to the controller. The abstract representation exposes a modality of controlling the functionality. The controller enables controlling the functionality through interaction with the abstract representation. The modality controls associate the control of the functionality with a modally compatible controlling capability of the controller.

(2) U.S. Pat. No. 6,076,166, issued Jun. 13, 2000 to Moshfeghi, et al., entitled PERSONALIZING HOSPITAL INTRANET WEB SITES.

While the invention has been shown and described with reference to certain preferred embodiments thereof, it will be understood by those skilled in the art that various changes in form and detail may be made therein without departing from the spirit and scope of the invention as defined by the appended claims.

What is claimed is:

1. A software application running on a local server having one or more associated local storage media and interfacing with a web-server, the application representing data stored in the one or more local storage media in a consistent GUI based on content, the web-server providing the local server with data in a compatible format for the application, the application organizing and presenting data accessible from the web-server on the GUI based on the content of the data provided.

2. The software application of claim 1, wherein the software application receives data downloaded from the web-server and stores the data in one of the associated local storage media, the application representing the downloaded data integrated with data stored in the one or more local storage media in a GUI based on content of the data.

3. The software application as in claim 2, wherein the software application is a music application.

4. The software application as in claim 2, wherein the local server has one or more associated devices that interface with the local server.

5. The software application as in claim 4, wherein the software application controls an associated device to utilize data stored in the one or more local storage media when the user selects the content of the stored data as represented on the GUI.

6. The software application of claim 2, wherein the GUI omits location of the storage medium of the data represented on the GUI.

7. The software application of claim 1, wherein the software application receives identification data for data that that is accessible from the web-server, the application representing the data accessible from the web-server integrated with data stored in the one or more local storage media in a GUI based on content of the data.

8. The software application of claim 7, wherein a selection of the data accessible from the web-server via the GUI initiates a stream of the data from the web-site.

9. The software application of claim 8, wherein the streamed data is used by a device that is associated with the local server.

10. A Graphical User Interface (GUI) generated by a software application running on a local server and having a connection to a remote network, the GUI representing data stored locally and in the remote network in standard displays that integrate the representation of data independent of where stored.

11. The GUI as in claim 10, wherein the GUI represents data in standard displays based on content.

12. The GUI as in claim 11, wherein the GUI controls an associated device to utilize data selected by a user based on the content represented in the GUI.

13. The GUI as in claim 11, wherein the software application initiates a download of data from the remote network selected by a user based on the content represented in the GUI.

14. The GUI as in claim 13, wherein the software application stores the downloaded data locally and causes the GUI to represent the downloaded data together with other data stored locally and in the remote network in standard displays that integrate the representation of data independent of where stored.

15. The GUI as in claim 12, wherein the software application initiates a stream of data from the remote network selected by a user based on the content represented in the GUI.

16. A system comprising a local server that interfaces with a remote network and runs at least one software application, the system having at least one associated storage medium for storage of local information, the software application initiating communication from the local server to the remote network to retrieve information from the remote network and storing the retrieved information on the at least one associated storage medium as local information, the retrieved information including specified data formatted in a pre-defined data format that is compatible with the at least one software application.

17. The system according to claim 16, wherein the local server interfaces with the remote web network via a web-server.

18. The system according to claim 17, wherein the web-server receives data in the predefined format from at least one data provider.

19. The system according to claim 18, wherein the at least one data provider is a web-site.

20. The system according to claim 18, wherein the web-server receives data from at least one data provider and transforms it into the pre-defined format.

21. The system according to claim 16, wherein the pre-defined data format is compatible with a standard GUI generated by the at least one software application.

22. A method of enabling a remote server to provide information to a local server, the method comprising the steps of storing information, selecting information that is applicable to a software application of the local server, and transferring the selected information to the local server, the information being in a format compatible with the software application.

23. The method of claim 22, wherein the remote server receives the information in a predefined format that is used by the software application.

24. The method of claim 22, wherein the remote server converts the information into a predefined format that is used by the software application.

25. The method of claim 22, wherein the remote server transfers the selected information to the local server in a format that is convertible by the local server into a pre-defined format used by the software application of the local server.

26. The method of claim 22, wherein the remote server receives the information from at least one web-site.

27. The method of claim 26, wherein the remote server receives the information in a predefined format that is used by the software application.

28. The method as in claim 22, wherein the selected information transferred to the local server comprises control information for a GUI associated with the local server.

29. The method as in claim 22, wherein the information in the pre-defined format comprises content information for the software application of the local server.

30. A method of enabling a software application of a local server to receive information from a remote server, the method comprising the steps of requesting information that is applicable to the software application, the requested information comprising at least one preference of an end user, and receiving selected information from the remote server in a format compatible with the software application, the selected information corresponding to the at least one preference.

31. The method of claim 30, wherein the local server receives the selected information in a pre-defined format that is used by the software application.

32. The method of claim 30, wherein the local server converts the selected information received into a pre-defined format that is used by the software application.

33. The method of claim 30, wherein the local server receives the selected information from a web-server.

34. The method of claim 33, wherein the web-server receives the selected information from at least one web-site.

35. The method of claim 33, wherein the web-server receives information from at least one web-site and selects the information that is received by the local server.

36. The method of claim 30, wherein the web-server converts the selected information that is received by the local server into a pre-defined format that is used by the software application.

37. The method as in claim 30, wherein the selected information received by the local server comprises control information for a GUI associated with the local server.

38. The method as in claim 30, wherein the selected information comprises content information for the software application of the local server.
